(19) United States
(12) Patent Application Publication
(10) Pub. No.: US 2013/0018511 A1
(43) Pub. Date: Jan. 17, 2013

(54) Control device for a linear actuator, particularly for the movement of sliding doors

(71) Applicant: Toni Cavalcante, Dueville (IT)

(72) Inventor: Toni Cavalcante, Dueville (IT)

(73) Assignee: TOPP S.P.A. A SOCIO UNICO

(21) Appl. No.: 13/374,382

(22) Filed: Dec. 27, 2011

(30) Foreign Application Priority Data
Jul. 15, 2011 (IT) PD2011A000243

(51) Int. Cl. G05B 15/02

(52) U.S. Cl. 700/275

(57) ABSTRACT

A control device for a linear actuator, the actuator being of the type comprising a body, to be fixed with corresponding elements of fixing between two jambs of a door, an electric motor being accommodated within the body which actuates a rotor that is adapted to interact with a rail, which is fixed to a door to be translationally moved, the body being coupled to the rail by way of a slide connected to the rail in order to enable the relative sliding between the body and the rail, the device further comprising
a microprocessor for commanding the electric motor,
an incremental encoder, rotary, on board the electric motor, defining the speed and the direction of motion of the rail and of the door to which it is fixed,
elements for the safe use of the linear actuator of which the control device is part.

The present invention relates to a control device for a permanent magnet linear actuator, particularly for the movement of sliding doors.

### BACKGROUND OF THE INVENTION

Nowadays, in the field of automation of the home and of habitable spaces generally, the use is becoming more and more widespread of actuators for opening and closing inner doors as well.

The automation of “pocket” sliding doors is however currently still not common, since such pocket sliding doors are normally installed to be moved manually, and a subsequent mounting of actuation means in order to automate the translational motion of the door is relatively complex and inconvenient.

In order to overcome the drawbacks of conventional linear actuators for doors, the same Applicant has devised a linear actuator particularly for sliding doors and for sliding door or window closure elements in general, the peculiar aspects of which are disclosed and claimed in Italian patent applications PD2011A000123, PD2011A000124, PD2011A000126, and PD2011A000127, such linear actuator comprising a box-like body, to be fixed with corresponding means of fixing between the two jambs of a door or of another frame, fixed drive means being accommodated within the box-like body which are adapted to move corresponding transmission means which are associated with the door. The drive means comprise an electric motor that actuates, by way of gear reducer means, a permanent magnet rotor.

The permanent magnet rotor is facing toward a guide rail, which is fixed to a door to be translationally moved, by way of a window defined on a slide that is connected to the rail and is adapted to slide with respect thereto.

The rail supports a row of second permanent magnets, where the first permanent magnets are understood to be those supported by the permanent magnet rotor, that are adapted to interact with the first permanent magnets of the rotor. The rail embodies the transmission means associated with the door.

The rotation of the permanent magnet rotor with respect to the row of permanent magnets of the rail causes the corresponding translational motion of the rail with respect to the rotor, and thus of the door to which the rail is fixed with respect to the box-like body which is fixed to the jambs of the door.

Since the mechanical safety of the linear actuator is ensured by the low kinetic energy produced by the door that is translationally moved, for safety of operation controlling the speed assumes importance even under conditions of failure or double failure of the very means of controlling the speed.

The problem described herein is felt in the above mentioned permanent magnet actuator, but it is also applicable to other, similar linear actuators, in which the interaction between rotor and rail is not magnetic, but mechanical, as in the case of a rail in the form of a rack and with the rotor defining the translation screw of an endless screw system.

### SUMMARY OF THE INVENTION

The aim of the present invention is to provide a control device for a linear actuator, particularly for the movement of sliding doors, that enables the actuation of the linear actuator of which it is a part in total safety, both for the mechanical part and for the electronic part of the actuator.

Within this aim, an object of the invention is to provide a control device the safety of which is ensured by way of hardware components, i.e. it is not delegated to peculiar aspects of programming of the electronic control unit.

Another object of the invention is to provide a control device for a linear actuator, particularly for the movement of sliding doors, which can be provided with known systems, technologies and components.

This aim and these objects, as well as others that will become better apparent hereinafter, are achieved by a control device for a linear actuator, particularly for the movement of sliding doors, the actuator being of the type comprising a box-like body, to be fixed with corresponding means of fixing between the two jambs of a door or of a window or door frame, an electric motor being accommodated within said box-like body which actuates a rotor that is adapted to interact, by way of a window defined on said box-like body, on a rail, which is fixed to a door to be translationally moved, said box-like body being coupled to said rail by way of a slide connected to said rail in order to enable the relative sliding between said box-like body and said rail, said device being characterized in that it comprises
a microprocessor for commanding the electric motor,
an incremental encoder, rotary, on board said electric motor, which is adapted to define the speed and the direction of motion of the rail and of the door to which it is fixed,
means for the safe use of the linear actuator of which the control device is part.

### BRIEF DESCRIPTION OF THE DRAWINGS

Further characteristics and advantages of the invention will become better apparent from the description of a preferred, but not exclusive, embodiment of the control device for a linear actuator, particularly for the movement of sliding doors, according to the invention, which is illustrated by way of non-limiting example in the accompanying drawings wherein:

FIG. 1 is a perspective view of a linear actuator on board which a control device according to the invention is installed;

FIG. 2 is a sectional side view of the actuator in FIG. 1;

FIG. 3 is a perspective view of a detail of the linear actuator in the preceding figures;

FIG. 4 is the same view as FIG. 3 but partially exploded, with first elements of the control device according to the invention visible;

FIG. 5 is a further partially exploded perspective view of the linear actuator in the preceding figures, with second elements of the control device according to the invention visible;

FIG. 6 is an enlarged view of a detail of FIG. 5;

FIG. 7 is a view of the components shown in exploded view in FIG. 5, assembled;

FIG. 8 is an electrical diagram of the device according to the invention.

### DESCRIPTION OF THE PREFERRED EMBODIMENTS

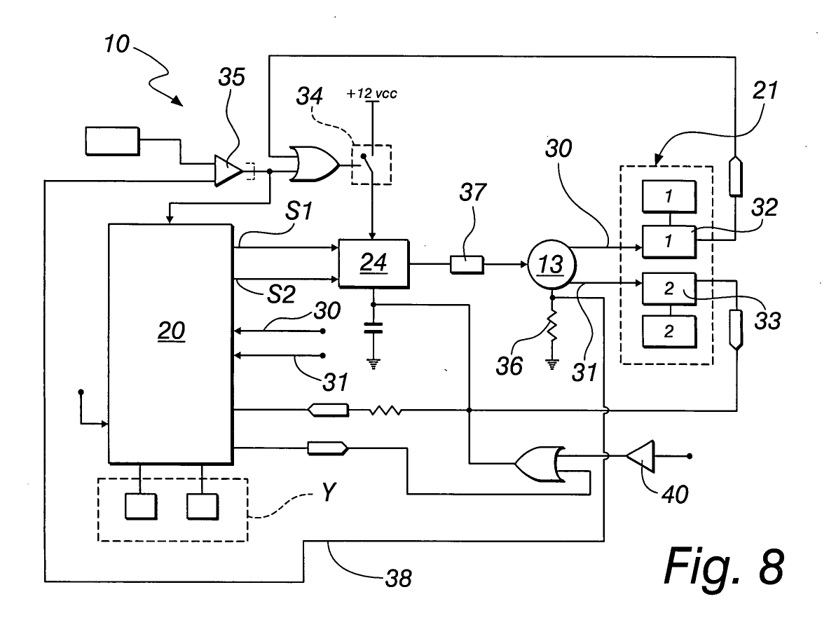

With reference to the figures, a control device according to the invention, for a linear actuator, particularly for the movement of sliding doors, is generally designated with the reference numeral 10 in the diagram in FIG. 8.

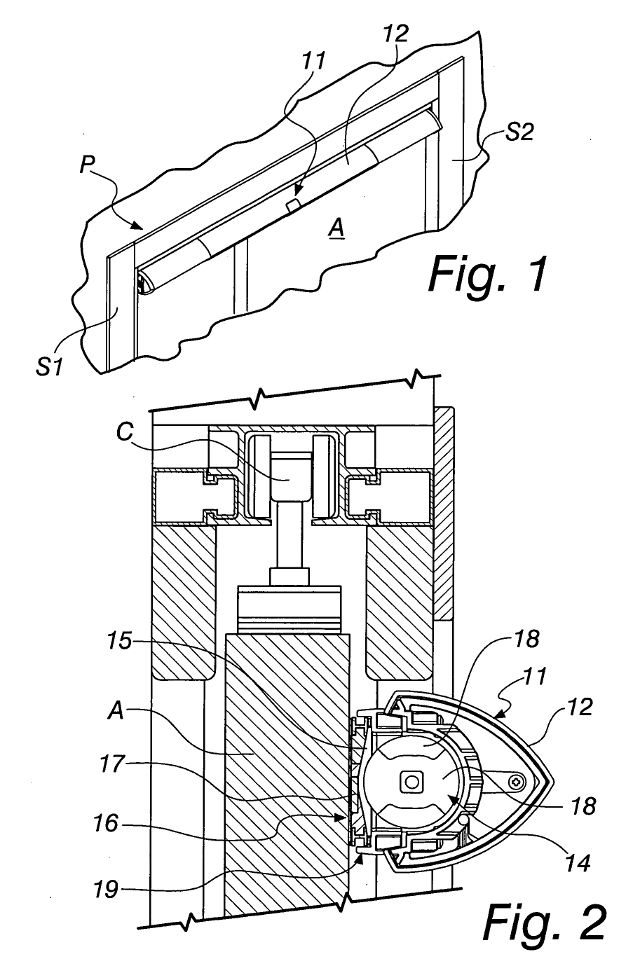

FIG. 1 shows a permanent magnet linear actuator 11 in which a device 10 according to the invention is installed.

The linear actuator 11 is of the type comprising a box-like body 12, to be fixed with corresponding means of fixing between the two jambs S1 and S2 of a door P, or of a window or door frame.

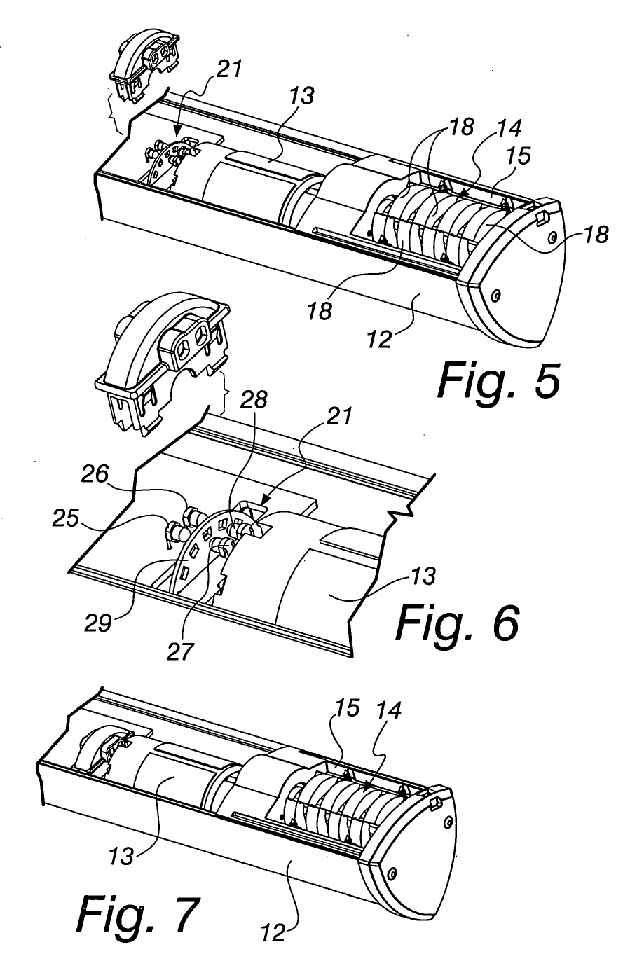

An electric motor 13, clearly visible in FIGS. 5 to 7, is accommodated within the box-like body 12, and actuates a permanent magnet rotor 14.

The permanent magnet rotor 14 faces, by way of a window 15 defined on the box-like body 12, onto a rail 16, which is fixed to a door A to be translationally moved.

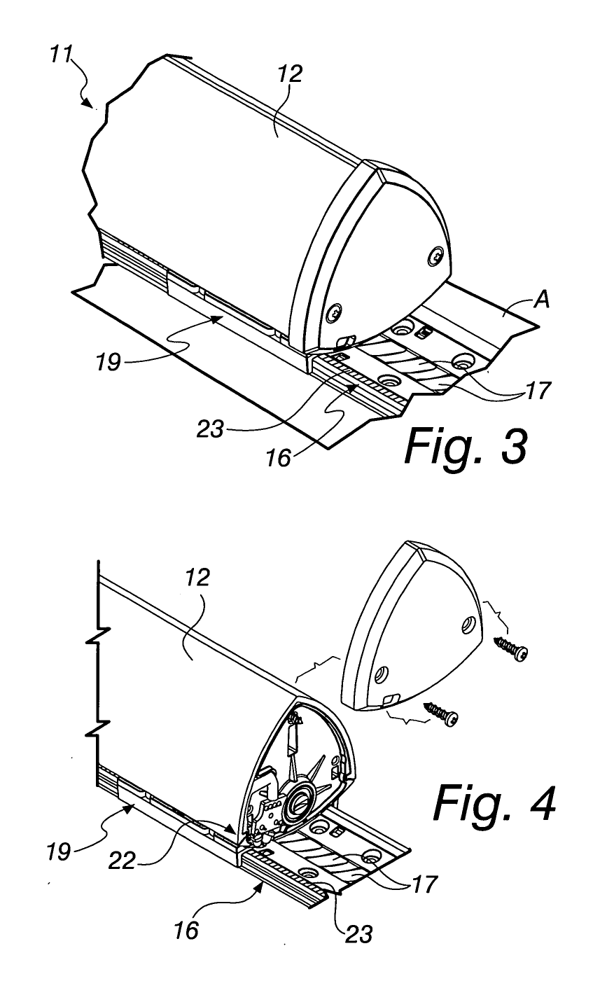

The rail 16 supports a row of permanent magnets 17, visible in FIGS. 3 and 4, that are adapted to interact with the permanent magnets 18 of the rotor 1, clearly visible in FIG. 5.

The box-like body 12 is coupled to the rail 16 by way of a slide 19 that is connected to the rail 16 in order to enable the relative sliding between the box-like body 12 and the rail 16.

The control device 10 according to the invention comprises:
a microprocessor 20 for commanding the electric motor 13, visible in the diagram in FIG. 8;
a first incremental encoder 21, rotary, on board the electric motor 13, which is adapted to define the speed and the direction of motion of the rail 16 and of the door A to which it is fixed;
a second incremental encoder 22, linear, supported by the box-like body to face the rail 16, on the rail a row of reference notches 23 being defined for detection by the linear encoder 22; the second encoder 22 is adapted to evaluate any losses of motility owing to the lack of magnetic interaction between the permanent magnet rotor 14 and the rail 16;
means for the safe use of the linear actuator 11 of which the control device 10 is part.

The microprocessor 20 commands the electric motor 13 to rotate in one direction or in the opposite direction by way of a H bridge 24, in its turn controlled by the microprocessor 20 by way of two distinct signals of the PWM (pulse width modulation) type, a first signal, designated in the diagram in FIG. 8 with S1, for opening the door P, and a second signal S2 for closing the door P.

The first incremental encoder 21 comprises two emitters 25 and 26, and two corresponding detectors 27 and 28, between which the disc 29 with perimetric equidistant windows is interposed, the latter item being fixed to the rotating shaft of the electric motor 13.

The double system of detection constituted by the two emitter-detector pairs produces two distinct signals, to each one of which a corresponding channel 30 and 31 leading back to the microprocessor 20 is respectively dedicated.

The means for the safe use of the linear actuator 11 consist of, for each channel 30 and 31, a comparator, 32 and 33 respectively.

Both of the comparators 32 and 33 compare the signal originating from the corresponding emitter-detector pair with a threshold value preset by way of an EEPROM chip Y of the rotation speed of the motor 13, such threshold value being a function of the weight of the door A that the linear actuator 11 is called on to move.

If the speed detected by both channels is below the preset threshold, then the kinetic energy of the moving door A is definitely below the maximum value imposed by the safety regulations, and the operation of the linear actuator 11 is considered to be safe.

If the speed detected by at least one of the channels is above the preset threshold, then the signal output by the first comparator 32 acts on a switch 34 so as to open the power supply circuit of the H bridge 24 that drives the motor 13, while the signal output by the second comparator 33 is routed directly to the H bridge 24, where it disables the driver of the H bridge 24, and to the microprocessor 20 which it notifies of the disabling.

In this manner the control device 10 offers a double protection system, i.e. a redundant system, against exceeding the safety speed.

Thus, in the event of an electronic failure that should cause an undue increase of the speed of the electric motor 13, the opening of the switch 34 is commanded by the signal output by the first comparator 32, and if for example the first comparator 32 also fails, the signal originating from the second comparator 33 still intervenes to deactivate the driver of the H bridge, thus still causing the switching-off of the motor 13.

The means for the safe use of the linear actuator 11 of the control device 10 according to the invention also comprise a safety system for the situation where the rotor of the motor 13 is blocked.

Such safety system is constituted by a third comparator 35 which is adapted to read the current that passes through the motor 13 by way of a shunt resistor 36 and compare it with a threshold value constituted by a preset current value which is established as the maximum for the motor 13.

The output signal from the third comparator 35 also intervenes by opening the switch 34 and cutting the power supply to the H bridge 24.

Such safety system in the event of blockage of the rotor of the motor 13 is provided with a safety redundancy component, constituted by a resettable fuse 37 wired in series with the motor 13.

The fuse 37 intervenes in the event of blockage of the rotor and simultaneous failure on the circuit 38 for controlling the current of the motor 13, and it causes the interruption of the flow of current to the motor 13.

The safety means for the linear actuator also comprise a timer 40, of the hardware type, which is adapted to cut the power supply to the H bridge 24 if a flow of current in the motor 13 beyond a preset time interval is reported. Such a situation can occur for example in the event of the magnetic decoupling of the rotor 14 from the rail 16, meaning that the motor 13 makes the rotor 14 rotate but there is no movement of the rail 16 with respect to the rotor 14 or there is less movement than expected.

Such a control device, without the second encoder 22, can be used in a similar manner also on a linear actuator in which the interaction between rotor and rail is mechanical and not magnetic, as in the case of a rail in the form of a rack and with the rotor defining the translation screw of an endless screw system.

In fact with such a linear actuator the coupling between rotor and rail is physically ensured by the meshing of the translation screw with the teeth of the rack, and there can be no slipping between the two elements.

In practice it has been found that the invention fully achieves the intended aim and objects.

In particular, with the invention a control device has been devised for a linear actuator, particularly for the movement of sliding doors, that enables the actuation of the linear actuator of which it is a part in total safety, both for the mechanical part and for the electronic part of the actuator.

Moreover, with the invention a control device has been devised the safety of which is ensured by way of hardware components, i.e. it is not delegated to peculiar aspects of programming of the electronic control unit.

Last but not least, with the invention a control device has been provided that can be applied both to linear actuators with permanent magnets, and to linear actuators of the mechanical type.

The invention, thus conceived, is susceptible of numerous modifications and variations, all of which are within the scope of the appended claims. Moreover, all the details may be substituted by other, technically equivalent elements.

In practice the materials employed, as well as the contingent dimensions and shapes, may be any according to requirements and to the state of the art.

The disclosures in Italian Patent Application No. PD2011A000243 from which this application claims priority are incorporated herein by reference.

What is claimed is:

1. A control device for a linear actuator, particularly for the movement of sliding doors, the actuator being of the type comprising a box-like body, to be fixed with corresponding means of fixing between the two jambs of a door or of a window or door frame, an electric motor being accommodated within said box-like body which actuates a rotor that is adapted to interact, by way of a window defined on said box-like body, on a rail, which is fixed to a door to be translationally moved, said box-like body being coupled to said rail by way of a slide connected to said rail in order to enable the relative sliding between said box-like body and said rail, said device further comprising
a microprocessor for commanding the electric motor,
an incremental encoder, rotary, on board said electric motor, which is adapted to define the speed and the direction of motion of the rail and of the door to which it is fixed,
means for the safe use of the linear actuator of which the control device is part.

2. The control device according to claim 1, wherein said microprocessor commands the electric motor to rotate in one direction or in the opposite direction by way of an H bridge, in its turn controlled by the microprocessor by way of two distinct signals, a first signal, for opening the door, and a second signal for closing the door.

3. The control device according to claim 2, wherein said incremental encoder comprises two emitters, and two corresponding detectors, between which the disc with perimetric equidistant windows is interposed, the latter item being fixed to the rotating shaft of the electric motor, said double system of detection, constituted by the two emitter-detector pairs, producing two distinct signals, to each one of which a corresponding channel leading back to the microprocessor is respectively dedicated.

4. The control device according to claim 3, wherein said means for the safe use of the linear actuator consist of, for each channel, a comparator, each one of which is adapted to compare the signal originating from the corresponding emitter-detector pair with a preset threshold value of the rotation speed of the motor in the EEPROM chip.

5. The control device according to claim 4, wherein the signal output by a first comparator is adapted to act on a switch so as to open the power supply circuit of the H bridge that drives the motor.

6. The control device according to claim 4, wherein the signal output by a second comparator is routed directly to the H bridge where it disables the driver of said H bridge, and to the microprocessor which it notifies of the disabling.

7. The control device according to claim 1, wherein said means for the safe use of the linear actuator comprise a safety system for the situation where the rotor of the motor is blocked.

8. The control device according to claim 7, wherein said safety system for the situation where the rotor of the motor is blocked is constituted by a third comparator which is adapted to read the current that passes through the motor by way of a shunt resistor and compare it with a threshold value constituted by a preset current value which is established as the maximum for the motor, the output signal from said third comparator being adapted to intervene by opening the switch and cutting the power supply to the H bridge.

9. The control device according to claim 7, wherein said safety system in the event of blockage of the rotor of the motor is provided with a safety redundancy component, constituted by a fuse wired in series with the motor, said fuse intervening in the event of blockage of the rotor and simultaneous failure on the circuit for controlling the current of the motor, by causing the interruption of the flow of current to the motor.

10. The control device according to claim 1, wherein said safety means for the linear actuator also comprise a timer, of the hardware type, which is adapted to cut the power supply to the H bridge if a flow of current in the motor beyond a preset time interval is reported.

11. The control device according to claim 1, further comprising a second incremental encoder, linear, supported by the box-like body to face the rail, on said rail a row of reference notches being defined for detection by said linear encoder, said second encoder being adapted to evaluate any losses of motility owing to the lack of magnetic interaction between the permanent magnet rotor and the rail.
